(19) United States
(12) Patent Application Publication
(10) Pub. No.: US 2007/0221855 A1
(43) Pub. Date: Sep. 27, 2007

(54) Scintillation crystal surface treatment

(76) Inventor: Jinhun Joung, Algunquin, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/386,406

(22) Filed: Mar. 22, 2006

(51) Int. Cl. G01T 1/20

(52) U.S. Cl. 250/368

(57) ABSTRACT

A method for enhancing the light output efficiency of a scintillation crystal, e.g. a NaI(Tl), scintillation crystal generally includes providing an input face of the scintillation crystal with a first set of substantially spaced apart, parallel channels that extend in a first direction along a portion of the input face of the crystal and providing a second set of substantially spaced apart, parallel channels in a portion of the input face of the crystal that extend in a second direction along a portion of the input face that is non-parallel to the first direction.

### FIELD OF THE INVENTION

The present invention relates generally to scintillation detectors for imaging devices, and more particularly, to scintillation crystal materials used in scintillation detectors

### BACKGROUND OF THE INVENTION

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body and are captured by a scintillation crystal, with which the photons interact to produce flashes of light or “events.” Events are detected by an array of photodetectors, such as photomultiplier tubes, and their spatial locations or positions are calculated and stored. In this way, an image of the organ or tissue under study is created from detection of the distribution of the radioisotopes in the body.

A number of scintillation crystals are known for use in nuclear medicine and each has particular advantages and disadvantages depending upon the type of nuclear imaging to be performed, the required image quality, cost of manufacture, light sharing scheme, type/size of a photomultiplier tube (PMT), detector/gantry geometry, performance in terms of sensitivity and spatial resolution, etc. Similarly, there are a number of known crystal surface treatments, which can affect image quality. Prior art approaches generally employ a series of channels cut or otherwise formed in the light output surface of the scintillation crystal. The purpose of the channels is to guide scintillation photons through the crystal and to minimize the lateral movement (“spreading”) of photons within the crystal. By minimizing spreading, the sensors are more likely to receive photons emanating from scintillation events located directly below them. The channels therefore function somewhat as collimators to direct or channel the photons in a direction substantially perpendicular to the plane of the scintillation crystal and/or perpendicular to the emission face. In one such prior art approach, as described, e.g., in U.S. Pat. No. 6,881,960, a scintillation crystal is formed with two sets of substantially orthogonal channels on its light output side which form a plurality of rectangular solid portions. The channels of this scintillation crystal are identical and have a uniform depth. Another prior art approach is disclosed in U.S. Pat. No. 6,841,783, which is incorporated by reference herein in its entirety. In the '783 patent, a scintillation crystal (Na(Tl)) is formed with two sets of substantially orthogonal channels on its light output side, however, the channels have varying depths.

While the above-identified, and other, surface treatments for output surfaces of scintillation crystals are known, there are few surface treatment methods for the input surfaces of scintillation crystals to prevent spreading, particularly with respect to relatively thick NaI(Tl) scintillation crystals that can be used for PET, or high energy SPECT applications. Indeed, a significant challenge in the development NaI based PET, and high energy SPECT, systems is that relatively thick scintillation crystals must be utilized in order to compensate for the low stopping power of NaI(Tl) crystals receiving 300 keV or 511 keV gamma photons. In sum, employing relatively thick crystals increases the scintillation light spread within the detector and degrades the spatial resolution

What is needed then are surface treatments for the input sides of scintillation crystals, particularly relatively thick NaI(Tl) scintillation crystals, that address the above-identified deficiencies.

### SUMMARY OF THE INVENTION

The present invention addresses the above identified deficiencies by providing a method and surface treatment for scintillation crystals used in radiographic imaging devices, particularly imaging devices utilizing high energy particles, e.g., 300, keV, 511 keV, etc. gamma photons, such as PET, and high energy SPECT, imaging devices. In one embodiment, the invention comprises a method for enhancing the light output efficiency of a scintillation crystal having an input face and an output face. The input face is configured for receiving a radiation particle and the output face is configured for emitting light photons produced in response to absorption of a radiation particle in the crystal. The method comprises providing the input face with a first set of channels having a first channel depth formed in a portion of the input face, wherein each channel extends in a first direction along the portion of the input face in a substantially parallel, spaced apart relationship with other channels in said first set. The method also comprises providing a second set of channels having a second channel depth formed in a portion of the input face wherein each channel of the second set of channels extends in a second direction along a portion of the input face in a substantially parallel, spaced apart relationship with other channels in the second set. The first and second directions are non-parallel to each other.

In one embodiment, the invention comprises a method for enhancing the light output efficiency of a scintillation crystal having an input face and an output face. In some embodiments of the invention, the first set of channels and the second set of channels intersect with one another. In some embodiments, the first set of channels and the second set of channels are orthogonal. In some embodiments, the channels comprise a pair of sides and a base side, and the pair of sides are parallel to one another. In some embodiments, the base side is substantially orthogonal with respect to the pair of sides. In some embodiments, the first set of channels has a depth that is equal to the depth of the second set of channels within a smallest obtainable manufacturing tolerance. In some embodiments, the depth of the channels is less than 10 millimeters. In some embodiments, the scintillation crystal has a thickness less than 5 centimeters and preferably, between 2 and 3 centimeters. In some embodiments, the scintillation crystal comprises NaI(Tl).

In some embodiments, the invention comprises a method for enhancing the light output efficiency of a NaI(Tl) scintillation crystal configured for use in PET or SPECT. In such embodiments, the method comprises providing an input face of the crystal with a first set of channels having a first channel depth formed in a portion of the input face, wherein each channel extends in a first direction along said portion of the input face in a substantially parallel, spaced apart relationship with other channels in said first set, and providing a second set of channels having a second channel depth formed in a portion of the input face, wherein each channel of the second set of channels extends in a second direction along a portion of the input face in a substantially parallel, spaced apart relationship with other channels in the second set, and wherein the second direction is non-parallel with the first direction.

In some embodiments wherein the crystal is a NaI(Tl) scintillation crystal, the crystal has thickness that is between 2 and 3 centimeters. In some embodiments wherein the crystal is a NaI(Tl) scintillation crystal, the first set of channels intersect and are substantially orthogonal with respect to the second set of channels. In some embodiments wherein the crystal is a NaI(Tl) scintillation crystal, a channel comprises a pair of sides and a base side and the pair of sides are parallel to one another. In some embodiments wherein the crystal is a NaI(Tl) scintillation crystal, the base side is substantially orthogonally disposed with respect to the pair of sides. In some embodiments wherein the crystal is a NaI(Tl) scintillation crystal, the first set of channels has a depth that is equal to the second set of channels within a smallest obtainable manufacturing tolerance. In some embodiments wherein the crystal is a NaI(Tl) scintillation crystal, the depth is less than 10 millimeters, and preferably between 2-8 centimeters.

In some embodiments according to the invention, a NaI(Tl) scintillation crystal having enhanced light output efficiency comprises an input face and an output face, wherein the input face is configured for receiving a radiation particle and the output face is configured for emitting a photon in response to absorption of the radiation particle. A first set of channels is formed in the input face and extend in a first direction along the input face in a substantially parallel, spaced apart relationship. A second set of channels is formed in the input face and extend in a second direction along the input face in a substantially parallel, spaced apart relationship. The first and second directions are non-parallel with one another.

### BRIEF DESCRIPTION OF THE DRAWINGS

The invention will now be more fully described by way of example with reference to the accompanying drawings in which:

FIGS. 1a-c are illustrations of a scintillation crystal and detector arrangement according to the invention;

FIG. 2a-2c are illustrations of a plurality scintillation crystal input face surface treatments;

FIG. 3 is a polar plot of the radiant intensity in the unified field;

FIGS. 4a-d are graphical representations of DSI simulator validation results (dashed line=detector, (a) paint surface case: representing Lambertian model, (b) metal coated surface case: representing specular reflector, (c) rough surface (alpha=45), (d) 4 holes f=5 cm, approximately (±10, ±10 cm) from a point of light source;

FIG. 5a-d are graphical representations of validation with experimental cases (dashed line (a) Ecam (⅜ inch) Detect, (b) Ecam (⅜ inch) DSI, (c) Ecam+ (⅝ inch) Detect, (d) Ecam+ (⅝ inch) DSI;

FIG. 6 is an illustration of expected two dimensional light distribution of a plurality of crystal surface treatments (Detected photons at the exit side of PMT photocathode are binned in 1 mm² pixels; artifacts are observed in duet, grooves and holes cases (Note: simulation conditions: Duet (grooves at exit side of the NaI, 6 mm pitch, 0.5 mm grooves, 12.7 mm groove depth), grooves (grooves at entrance side of the NaI, 5 mm, 0.5 mm grooves, 6 mm groove depth), holes (2 mm pitch, 1 mm diameter, 25.4 mm height), pyramid (cones at entrance side of the NaI, 4 mm cones base, 2 mm height));

FIGS. 7a-d are graphical representations of the expected light response function for a plurality of crystal surface treatments ((a) 1″ standard (b) holes (c) entrance grooves (d) retro-reflector; dashed line represents ⅜ inch LRF);

FIGS. 8a-d are graphical representations of examples of CR bound curve as a function of position ((a) entrance side grooves (b) holes (c) retro-reflector (c) duet (e) 1″ standard (f) ⅝ inch E.cam plus; dashed line represents CR bound for ⅜ inch E.cam as a reference CR);

FIGS. 9a-b are graphical representations of the expected performance of crystal surface treatments ((a) CR lower bound (b) light collection efficiency; all values are normalized against 1″ standard case performance);

FIGS. 10a-d are graphical representations of Depth of Interaction dependency of Light Response Functions (LRFs) ((a) 1″ standard (b) retro-reflector (c) duet (c) entrance grooves; BLK: shallow events, BLU: middle events, R: deep events);

FIG. 11 is a graphical representation of expected LRFs for a plurality of crystal surface treatments;

FIGS. 12a-b are graphical representations of LRF control effects on spatial resolution and Light Output efficiency (LOE); and

FIGS. 13a-f are graphical representations of Mean Point Spread Function (MPSF) for a plurality of crystal surface treatments (MPSF_{fwhm} (a) 1″ standard (b) retro-reflector (c) ⅜ inch E.cam (d) Duet (e) holes (f) entrance grooves).

### DETAILED DESCRIPTION OF THE INVENTION

The present invention will now be described and disclosed in further detail. It is to be understood, however, that the disclosed embodiments are merely exemplary of the invention and that the invention may be embodied in various and alternative forms. Therefore, specific structural and functional details disclosed herein are not to be interpreted as limiting the scope of the claims, but are merely provided as an example to teach one having ordinary skill in the art to make and use the invention.

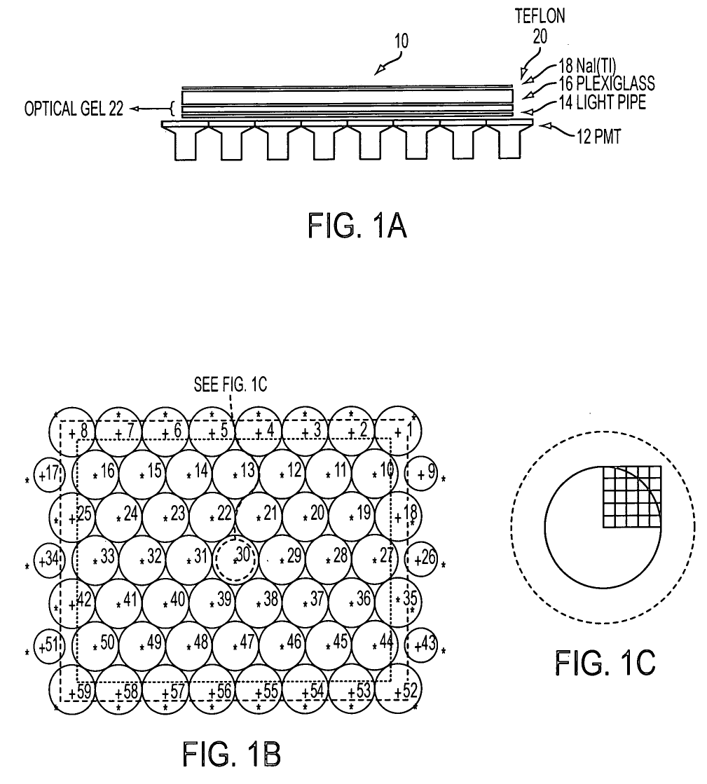

Adverting now to the figures, FIG. 1 illustrates an exemplary embodiment of a scintillation crystal and detector arrangement 10 according to the invention as broadly comprising PMTs 12, light pipe 14, Plexiglas 16, crystal 18, which preferably comprises NaI(Tl), and Teflon 20. Optical gel 22 may be disposed between one or more of the PMTs 12, light pipe 14, Plexiglas 16, scintillation crystal 18, and Teflon 20. As shown, the PMTs may be configured in a hexagonal arrangement. The scintillation crystal 18 may be employed in a radiographic imaging device, such as a PET or SPECT scanning system. In the embodiment illustrated, scintillation crystal 18 has a thickness that is less than 5 millimeters (mm) and is approximately 25 millimeters (mm) and comprises NaI(Tl). The scintillation crystal 18 may comprise other materials.

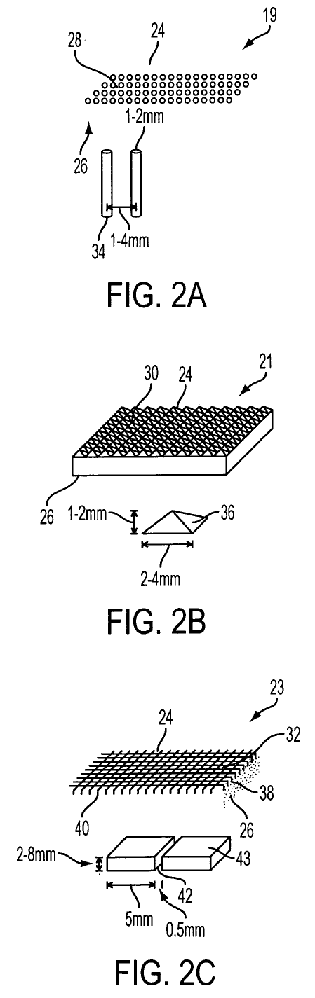

Referring now to FIGS. 2a-c, which illustrate scintillation crystal 18 as comprising input face surface treatments to thereby form scintillating crystals 19, 21 and 23. Each of scintillating crystals 19, 21 and 23 broadly comprise input face 24, which are configured for receiving a radiation particle, and output face 26, which is configured for emitting photons in response to absorption of a radiation particle. Input face 24 of each scintillating crystal 19, 21 and 23 can be planar or arced and can be configured to comprise one or more of the surface treatments. In FIGS. 2a-c scintillating crystals are shown as comprising holed surface 28, retro reflector surface 30, and grooved surface 32, respectively.

Holed surface 28 can be formed by drilling one or more holes 34 into the surface of the input face by suitable means, such as by means of a drill, and in the embodiment illustrated each hole 34 has a diameter between 1-2 mm and is separated from another by a distance of 1-4 mm. Holes 34 can be arranged in rows, offset rows, or can be randomly disposed about the input face of the crystal 18. In some embodiments, the height, or depth of holes 18 can be at least 25 mm.

Retro-reflector surface 30 can be formed from a plurality of pyramid-shaped structures 36 having a height between 1-2 mm and a width of base between 2-4 mm. The pyramid-shaped structures 36 of the retro-reflector surface 30 can be formed by suitable means such as milling.

Scintillation crystal 23 comprising grooved surface 32 is shown as comprising a first set 38 of channels 42 and a second set 40 of channels 42. In the embodiment illustrated, channels 42 of the first set 38 are formed in a spaced apart parallel relationship with respect to one another and extend in a first direction. Similarly, channels 42 of the second set 40 are formed in a spaced apart parallel relationship with respect to one another and extend in a second direction. In the embodiment illustrated, first set 38 is formed substantially perpendicular to the second set 40. The two sets of channels 42, thus, are illustrated as forming a plurality of substantially rectangular solid portions 43, each which comprises a portion of the input face 24. In the embodiment illustrated, channels 42 have a generally square, or rectangular, cross sectional shape and have a width of approximately 0.5 millimeters (mm), a depth of between 2-8 millimeters (mm), and form a rectangular solid portion 43 that has a width of approximately 5 millimeters (mm).

In the embodiment illustrated, channels 42 of each set are preferably substantially uniform. That is, each is preferably similar in width, depth, and cross-sectional shape. In a preferred embodiment, the channels include a pair of parallel sides 44 and a base side 46, which is orthogonally disposed with respect to the parallel sides 44. It should be appreciated that while first and second sets 38, 40 of channels 42 are illustrated as being orthogonally disposed with respect to one another, other angular configurations may be desirable. Similarly, while sides 44 are described as being parallel with respect to one another and orthogonal with respect to base side 46, one or more of the sides 44 may be disposed at other angles. Similarly, base side 46, while being described as being essentially planar by virtue of its being orthogonally disposed with respect to sides 44, may be angled or arced. Preferably, however, channel 42 has a generally square or rectangular cross sectional shape. Channels 42 may be formed by milling crystal 18, or by other suitable process. Channels 42, while illustrated as comprising air gaps, may be configured to comprise other materials, such as reflective powder, or other solid material, etc. While in a preferred embodiment, scintillation crystal 18 is less than 5 centimeters thick from input face to output face, and preferably between 2-3 centimeters, for other crystal thicknesses, the ratios of the depths of the channels to the thickness of the crystal may vary as a function of crystal thickness as the relationship of channel depth to crystal thickness is non-linear, but may be determined readily through experimentation and testing. It should be understood that the numbers described above are merely exemplary, and the spacing, width, and depth may be changed and still remain within the scope of the invention.

Experiments

Conditions

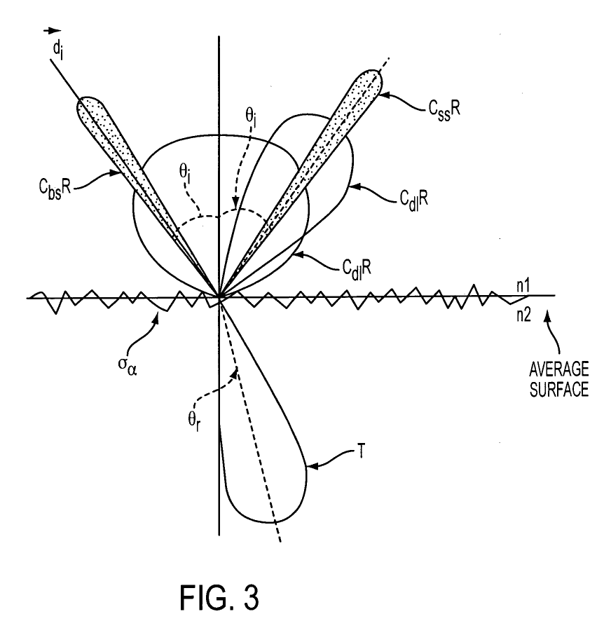

Referring now to FIGS. 3-13, simulated experiments were conducted to determine the light distribution effects of the above-described input face surface treatments upon relatively thick NaI scintillation crystals (2-3 centimeters (cm)). To perform the experiments two Monte Carlo simulators, Detect (2001 beta version) and DSI, were used to simulate photon transport through a number of crystal assemblies. The Detect simulator is a widely used simulator for photon transfer simulation in the field of nuclear medicine and is publicly available. The DSI simulator is available from Digital Scintigraphics Inc. of Boston, Mass.

The experiments were conducted on the detector geometries, optical conditions and PMT allocations described in FIG. 1. The optical conditions and PMT size/allocations were followed by that of the Duet system, thus allowing the use of the same gantry, detector can and electronics for the initial experimental investigation phase. For the Mean Point Spread Function (MPSF) test, evenly spaced 5×5 test points were selected within a 4×4 cm area illustrated in FIG. 1.

The surface modeling, sampling and user interface of the DSI simulator was modeled after the Detect Simulator and was validated with the Detect simulator. The two simulators were then validated with known experimental cases of E.cam and E.Cam+ systems, commercially available from Siemens Medical Solutions USA, Inc. of Hoffman Estates, Ill.

Quality Factors

FIG. 2 illustrates the three crystal input face surface treatments utilized in the experiments, whose holes, retro-reflectors and groove sizes may be modified. Several quality factors that affect images reconstructed from scintillating cameras were examined, however, the intrinsic performance, i.e., the spatial and energy resolution, linearity, sensitivity, and uniformity of a detector were the primary factors examined. The factors examined are typically affected by statistical fluctuations i.e., signal-to-noise ratio of a phototube signal; the error propagation characteristics of a positioning estimator, and the statistical properties of the photon distribution, i.e., the shape of light response function.

The statistical fluctuation is generally dependant upon the Light Output Efficiency (LOE) of a crystal, the quantum efficiency of PMT photocathodes and the noise characteristics of a photomultiplier tube. The conversion efficiency and noise characteristics are intrinsic properties of a PMT. Consequently, LOE and, therefore, high signal to noise ratio, is important to the design of an optimal detector.

Anger type positioning algorithms are the predominant positioning estimators for scintillation cameras because of their relatively simple hardware realization and reasonable performance. However, such methods, e.g., linear least square type, are known to be biased and not efficient estimators. Alternative positioning algorithms utilizing statistical properties include maximum likelihood method, transfer function approach and statistics based positioning algorithms. Although such type estimators typically require additional electronics and computational resources, it can be worthwhile to utilize optimum positioning algorithms to improve the system performance, including edge effect artifacts.

Generally, the shape of the Light Response Function (LRF) determines the fundamental performance of a given system and it is most sensitive to thickness, the shape and surface treatment, and light guide configuration of a crystal. The quality factor information was extracted from the LRF, the quality factors are:

1.) Light output efficiency: LOE(%)=(detected photons/total simulated photons)×100

2.) Cramer Rao Lower bound (unbiased case): The CR lower bound, derived in equation (1), was used to determine the best standard deviation, i.e., spatial resolution obtainable from the given LRF of detector geometry. Note that the CR lower bound is a function of the LRF, in other words, the intrinsic shape (slope) of the LRF of a given system determines the spatial resolution of the system. Also, CR provides a scalar performance index that is useful for selecting the optimum configuration of an imaging system.

$${σ}_{l b}^{2} ( x ) \geq {E [ \frac{{\partial }^{2} ln pr [ \overline{M} \vert x ]}{\partial {x}^{2}} ]}^{- 1} \\ right side of equation can be derived {to [ {\sum }_{i = 1}^{N} \frac{{( \partial {S}_{i} ( x ) / \partial x )}^{2}}{{S}_{i} ( x )} ]}^{- 1} \qquad ( 1 )$$

where Sᵢ(x) represents LRF of i^{th} PMT.

3) Mean of Point Spread Function FWHM (MPSF_{fwhm}): Although CR lower bound is useful when to examine the performance potential of different imaging system geometries, the equation (1) is derived based on the unbiased assumption so that it is inapplicable where bias is unavoidable situation. On the other hand, the FWHM of PSF of a camera is a hallmark of performance assessment. The individual FWHM of PSF at x and y direction is separately calculated at each test point defined in FIG. 1 and the mean PSF_{fwhm} value of test points represents MPSF_{fwhm} as a single scalar assessment index for x and y direction.

$${MPSF}_{fwhm} = \frac{1}{25} {\sum }_{i = 1}^{25} {PSF}_{fwhm} \qquad ( 2 )$$

where, PSF_{fwhm}=σ×2.35 and σ is computed based on Gaussian fitting to the point spread function at each test point.
   Simulator Validation

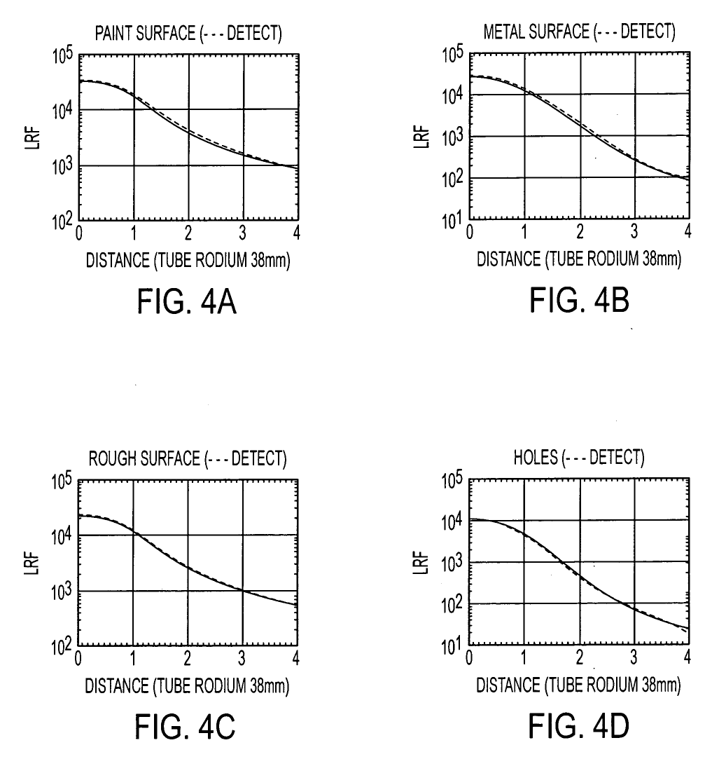

Photon transport and interaction models at the boundary of optical components and random sampling models of DSI stimulator were examined against that of the Detect simulator. The validation of surface modeling including Lambertian, specular and rough case are shown in FIG. 4 which shows good agreement between the two simulators for all test cases. In rough surface modeling, Detect uses a so called “unified model” that includes σ_{α}, the angle between a micro-facet normal and the average surface normal, and four major control parameters such as specular lobe, specular spike, backscatter spike and diffuse lobe as shown in FIG. 3. DSI follows simple rough surface model with a single parameter that represents the slope of micro-facet normal to the surface normal.

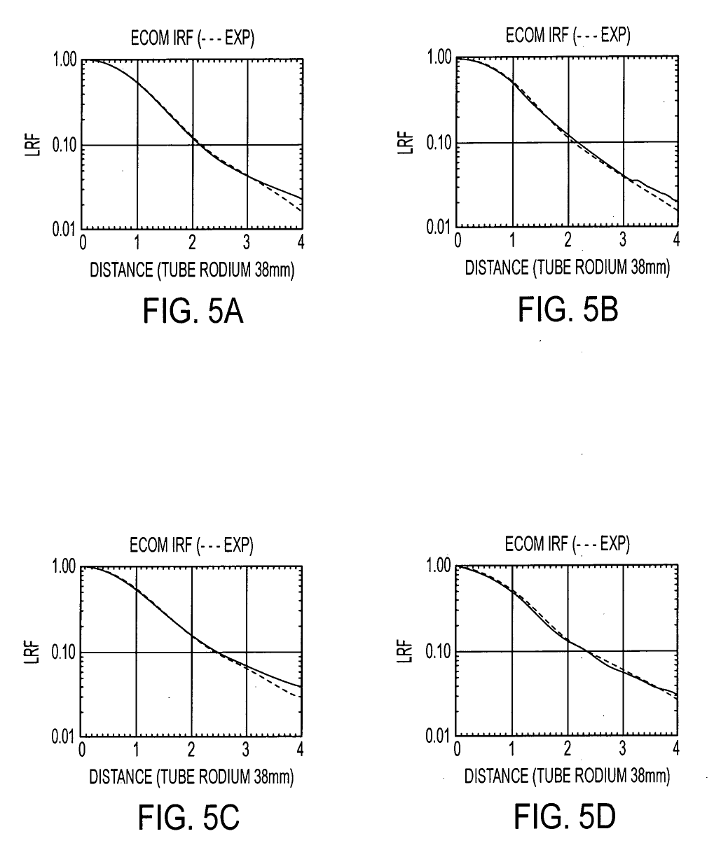

Further validation of the two simulators was performed with known experimental cases, i.e., E Cam (⅜) and E Cam+(⅝). FIG. 5 illustrates validation results with experimental cases. Detect simulation has good agreement with experimental results up to about 3 PMT radius interval, and slightly underestimates tails of LRF for both cases. Considering the fact that approximately 7 to 12 PMTs (˜3 PMT radius) are utilized in the positioning process and tails of LRF are usually cut out by bias subtraction schemes, the slight mismatch at the tail part of the LRF may not be significant. On the other hand, there was a noticeable discrepancy between DSI simulation and experimental results within 3 PMT radius section.

Light Output Efficiency

Light Output Efficiency (LOE %) was tested for all proposed manipulation methods and the E Cam series. LOE generally represents the expected energy resolution performance of a given method. Table 1 summarizes LOE results. It should be appreciated that manipulating the entrance side of the crystal surface enhanced its light output efficiency.

TABLE 1
LOE Summary

| | ⅜ | | | | R- | |
|---|---|---|---|---|---|---|
| | Inch | 1 Inch | Duet | Holes | reflectors | Ent. Grooves |
| LOE (%) | 72 | 65 | 66 | 65 | 72 | 82 |

Two Dimensional Light Distribution

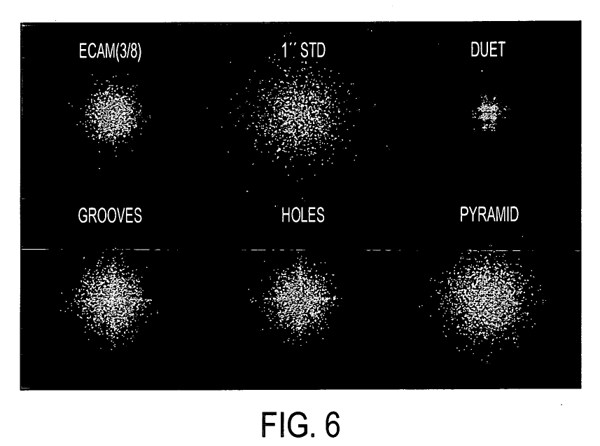

FIG. 6 illustrates two dimensional light distribution. A highly collimated point source is assumed to be located at the center of a detector (detector's geometrical dimension and PMT allocation is shown in FIG. 1. Exponential depth of interaction is considered based on Co57 (122 keV) interaction probability within a NaI crystal. Star and block artifact is clearly observed in the cases of holes, Duet and entrance grooves. The artifacts are caused by physical crystal manipulation and unequal surface interaction of photons which head toward certain directions. However, considering that event positions can be estimated from the relatively large PMT samplings, the artifacts may not significantly affect the performance of the positioning algorithm.

Light Response Function (LRF)

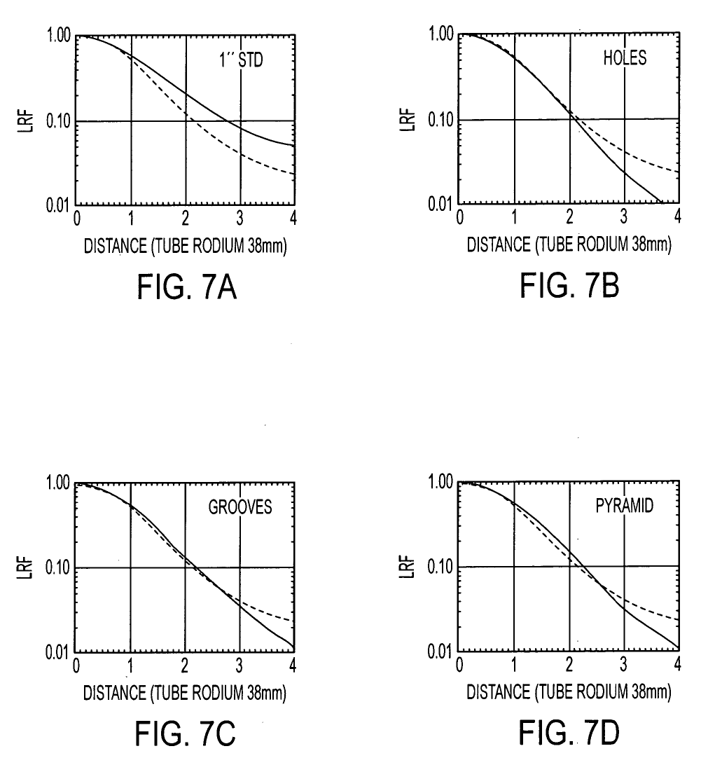

In practice, Light Response Function (LRF) is obtained by moving a highly collimated point source on a known grid with desired precision. In the simulation, one dimensional light response function was derived from the two dimensional light distribution shown in FIG. 7. Instead of moving a point source, a virtual 3 inch PMT was moved along in one direction and photons that fell within the 3 inch PMT area were summed to represent light response function as a function of position.

Cramer Rao Lower Bound

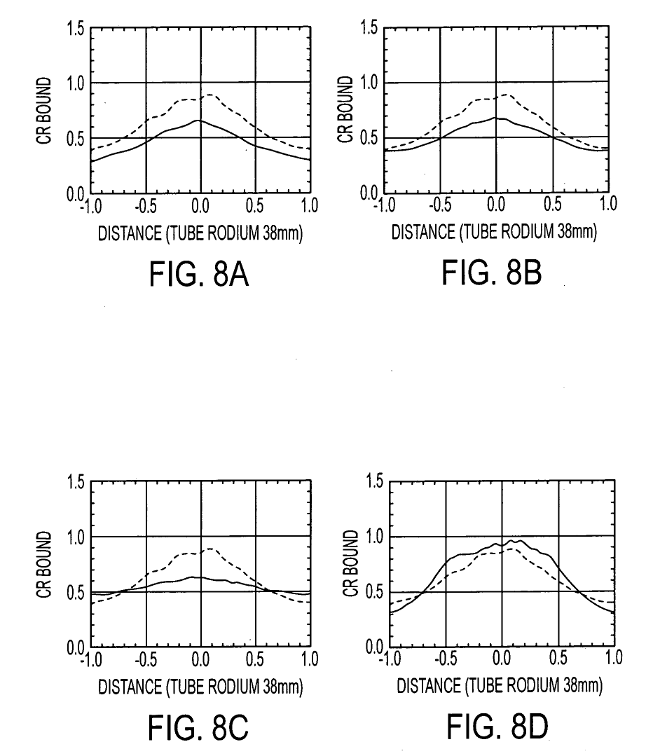

Cramer Rao (CR) Bound was derived assuming a total of 5 PMTs in a row were utilized in estimating event positions for one direction. FIG. 8 illustrates examples of CR bound curve as a function of position. It is seen that the entrance side groove provides a greater CR performance while retro-reflector provides uniform CR-bound performance independent of position. Also, it should be appreciated that CR bound value is computed assuming PMT noise is zero. In practice, the PMT noise scales the CR performance. y≈Poisson ( y̅(θ)+n), where θ is a function x, y and z. And, n represents PMT noise.

Performance

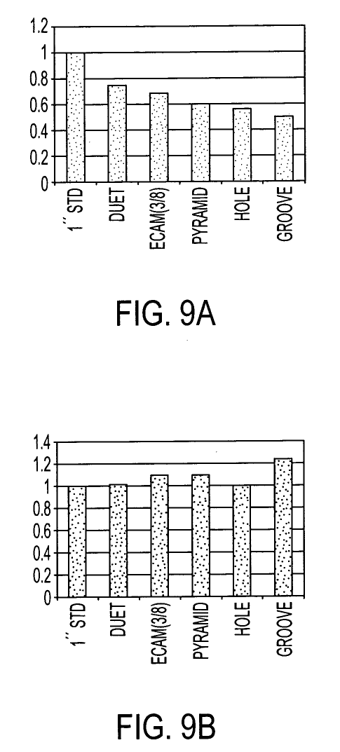

Expected performance of the crystals is summarized in FIG. 9. The CR performance represents expected spatial resolution performance and energy resolution can be predicted from the total light collection efficiency. As can be seen from the figure, input face/entrance side grooves provide superior spatial and energy resolution performance over the other surface treatments.

Depth of Interaction Decodeability

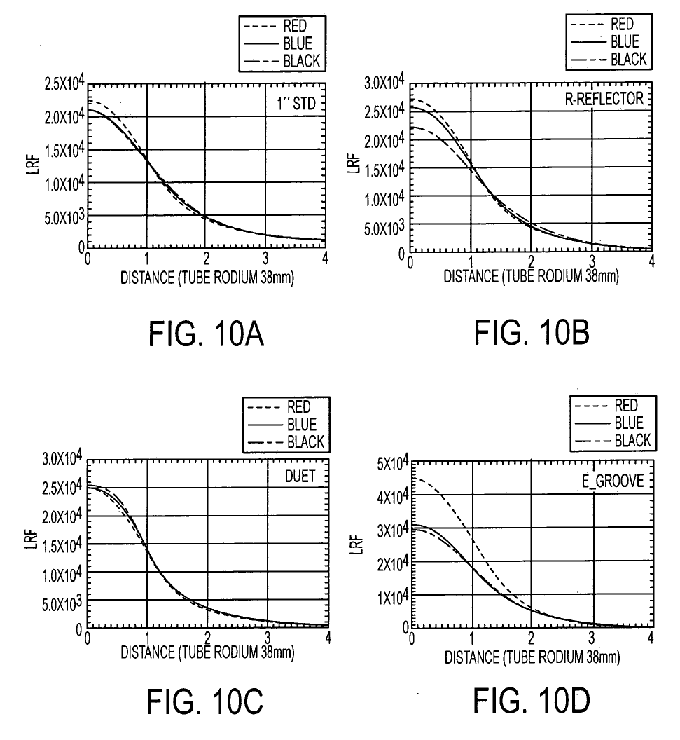

Depth of Interaction (DOI) dependent or independent LRF is an important property of a scintillation system, especially for positron imaging and single photon imaging with pinhole collimation. For example, DOI independent LRF is desired in SPECT systems for a uniform performance regardless of depth of event interaction while in PET systems DOI dependent LRF is desirable to allow easy DOI decoding features to minimize parallax errors, FIG. 10 illustrates LRFs at shallow (3 mm from the input face/entrance surface), middle (12 mm from the input face/entrance surface) and deep (22 mm from the input face/entrance surface) events. As can be seen, Duet system provides DOI independent LRFs while shallow LRF is easily decodable from the middle and deep LRF in the case of the entrance groove cut method.

Although some manipulation techniques provide DOI dependent LRF, conventional Anger style positioning algorithms are not suitable to decode depth depend events since they are designed to find a centroid of a given LRF. To have a DOI decoding feature based on LRF, sophisticated positioning algorithms based on statistics and/or detector characteristics may be employed.

LRF Control

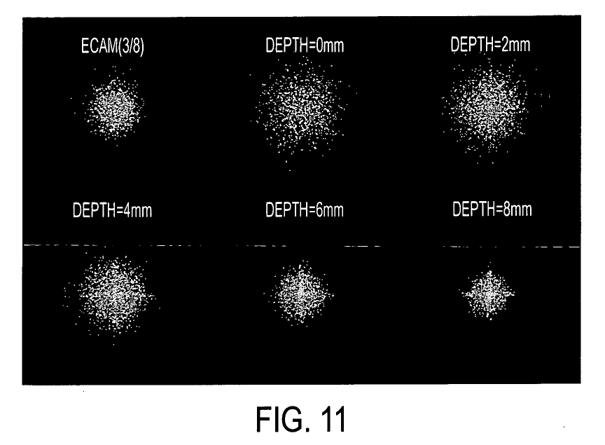

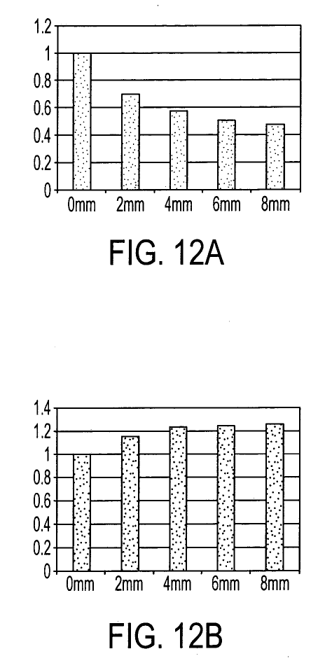

The ease of LRF control property is an important quality factor. FIG. 11 illustrates an example of LRF control and FIG. 12 summarizes its effects in terms of CR performance and LOE. In the figures only the input face/entrance groove case is investigated. However, the hole case presumably provides similar control effects to entrance groove cut by employing a diverse combination of holes with differing size, depth density, and/or direction but LOE may not be predictable.

Mean Point Spread Function

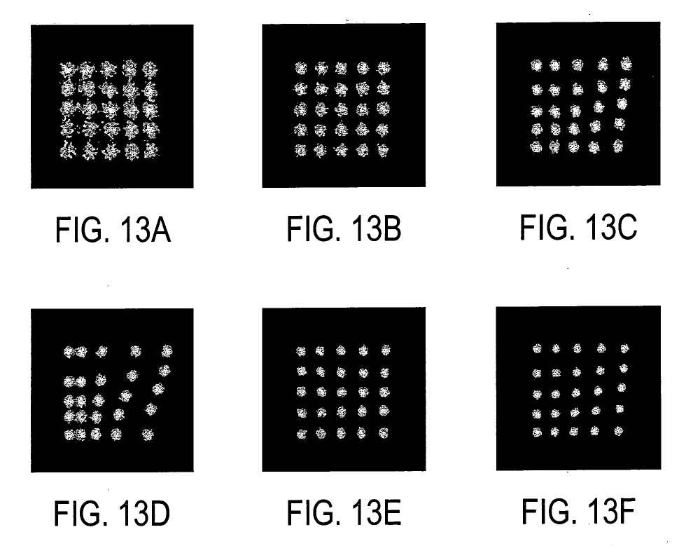

As previously discussed, CR lower bound is a useful tool for assessing system performance. However, point spread function or modular transfer function is a good objective intrinsic spatial resolution assessment tool for a given system. Although MPSF was conducted based on Monte Carlo simulation, it provides expected spatial resolution performance of a given system with a high confidence level. One thousand events were simulated at each test point described in FIG. 2 in order to generate enough events for statistical evaluation and the DOI was fixed at 3 mm from the entrance surface. FIG. 13 provides a graphical overview of the overall performance of the samples in terms of linearity and spatial resolution performance. Table 2 summarizes MPSF_{fwhm} performance of the samples. As can be seen, expected resolution performance among the cases based on CR observation is well matched with that of MPSF, except the retro-reflector case (Note that the spatial resolution degradation due to the linearity correction is not considered. The ⅜″ values are somewhat higher than the known experimental NEMA test results. However, the MPSF_{fwhm} gives relative performance expectations. *The duet result will be worsen after linearity correction due to the high degree of bias.)

TABLE 2
MPSF_{FWHM} Performance Summary

| | 1″ | | | R- | | E- |
|---|---|---|---|---|---|---|
| FWHM(mm) | standard | Duet | Ecam(⅜) | reflector | Holes | grooves |
| FWHMₓ | 6.26 | 4.22* | 4.21 | 5.23 | 3.79 | 3.22 |
| FWHM_{y} | 6.37 | 4.33* | 4.40 | 5.12 | 3.93 | 3.23 |

In view of the foregoing, it is seen that a NaI scintillation crystal having an input face comprising a grooved or channeled surface enhances a number of factors that affects crystal output, particularly light output efficiency, spatial and energy resolution, DOI dependency and uniformity. Consequently, a method of enhancing light output efficiency of relatively thick NaI scintillation crystals generally includes providing a plurality of grooved or channeled surfaces on the input face of the crystal.

It should be appreciated by those having ordinary skill in the art that while the present invention has been illustrated and described in what is deemed to be the preferred embodiments, various changes and modifications may be made to the invention without departing from the spirit and scope of the invention. Therefore, it should be understood that the present invention is not limited to the particular embodiments disclosed herein.

What is claimed is:

1. A method of enhancing light output efficiency of a scintillation crystal comprising an input face and an output face, said input face configured for receiving a radiation particle, said output face configured for emitting a photon in response to absorption of said radiation particle, said method of enhancing comprising:
providing said input face with a first set of channels having a first channel depth formed in a portion of said input face, each channel extending in a first direction along said portion of said input face in a substantially parallel, spaced apart relationship with other channels in said first set; and,
providing a second set of channels having a second channel depth formed in a portion of said input face, each channel of said second set of channels extending in a second direction along a portion of said input face in a substantially parallel, spaced apart relationship with other channels in said second set, said second direction being non-parallel with said first direction.

2. The method of claim 1, wherein said first set of channels intersect said second set of channels.

3. The method of claim 1 wherein said first set of channels are substantially orthogonal with respect to said second set of channels.

4. The method of claim 1, wherein a channel comprises a pair of sides and a base side, said pair of sides being parallel to one another.

5. The method of claim 4, wherein said base side is substantially orthogonal with respect to said pair of sides.

6. The method of claim 1 wherein a channel comprises a pair of sides angularly disposed with respect to one another.

7. The method of claim 1, wherein said first set of channels has a depth that is equal to said second set of channels within a smallest obtainable manufacturing tolerance.

8. The method of claim 4 wherein said depth is less than 10 millimeters.

9. The method of claim 1 wherein said scintillation crystal has a thickness less than 5 centimeters.

10. The method of claim 9 wherein said thickness is between 2 and 3 centimeters.

11. The method of claim 1 wherein said scintillation crystal comprises NaI(Tl).

12. The method of claim 11 wherein said scintillating crystal is used in association with a PET radiative imaging system.

13. The method of claim 11 wherein said scintillating crystal is used in association with a SPECT radiative imaging system.

14. A NaI(Tl) scintillation crystal configured for use with a radiative energy imaging system, said NaI(Tl) scintillation crystal comprising:
an input face and an output face, said input face configured for receiving a radiation particle, said output face configured for emitting a photon in response to absorption of said radiation particle an input face receiving a emission face from which photons are emitted in response to absorption of radiation;
a first set of channels formed in an said input face, each channel extending in a first direction along said input face in a substantially parallel, spaced apart relationship with other channels in said first set; and
a second set of channels formed in said input face, each channel of said second set of channels extending in a second direction along said input face in a substantially parallel, spaced apart relationship with other channels in said second set, said second direction being non-parallel with said first direction.

15. The scintillation crystal of claim 14 wherein said crystal has a thickness that is between 2 and 3 centimeters.

16. The scintillation crystal of claim 15, wherein said first set of channels intersect and are substantially orthogonal with respect to said second set of channels.

17. The scintillation crystal of claim 16, wherein a channel comprises a pair of sides and a base side, said pair of sides being parallel to one another.

18. The scintillation crystal of claim 17, wherein said base side is substantially orthogonally disposed with respect to said pair of sides.

19. The scintillation crystal of claim 18, wherein said first set of channels has a depth that is equal to said second set of channels within a smallest obtainable manufacturing tolerance.

20. The scintillation crystal of claim 19 wherein said depth is less than 10 millimeters.

21. The scintillation crystal of claim 20 wherein said depth is between 2-8 centimeters.

22. The scintillation crystal of claim 14 used in association with a PET radiative imaging system.

23. The scintillation crystal of claim 14 used in association with a SPECT radiative imaging system.

24. A method of increasing the light output efficiency of a NaI(Tl) scintillation crystal for use with a radiative energy imaging system, said method comprising:
providing an input face of said crystal with a first set of channels having a first channel depth formed in a portion of said input face, each channel extending in a first direction along said portion of said input face in a substantially parallel, spaced apart relationship with other channels in said first set;
providing a second set of channels having a second channel depth formed in a portion of said input face, each channel of said second set of channels extending in a second direction along a portion of said input face in a substantially parallel, spaced apart relationship with other channels in said second set, said second direction being non-parallel with said first direction.

25. The method of claims 24 wherein said scintillation crystal is used in association with a PET radiative imaging system.

26. The method of claim 24 wherein said scintillation crystal is used in association with a SPECT radiative imaging system.
